(19) United States
(12) Patent Application Publication
(10) Pub. No.: US 2010/0103268 A1
(43) Pub. Date: Apr. 29, 2010

(54) DIGITAL CAMERA

(76) Inventor: Katsumi TOKUYAMA, Osaka (JP)

Correspondence Address: MCDERMOTT WILL & EMERY LLP, 600 13TH STREET, NW, WASHINGTON, DC, 20005-3096, US

(21) Appl. No.: 12/573,566

(22) Filed: Oct. 5, 2009

(30) Foreign Application Priority Data
Oct. 23, 2008 (JP) 2008-273018

(51) Int. Cl. H04N 5/30; H04N 9/68

(52) U.S. Cl. 348/162; 348/235; 348/E05.085; 348/E09.053

(57) ABSTRACT

A generator generates a visible light video signal by receiving visible light and generating an invisible light video signal by receiving invisible light. A synthesizer synthesizes the visible light video signal and the invisible light video signal in such a manner that a synthesis ratio can be changed. An adjuster receives parameters relating to image synthesis inputted by an operator from outside and adjusts the synthesis ratio based on the received parameters. A display unit generates a synthetic image from a synthetic video signal and displays the synthetic image. Then, the parameters inputted to the adjuster by the operator are received and the synthesis ratio is changed by the adjuster based on the received parameters while the synthetic image is being displayed by the display unit.

### BACKGROUND OF THE INVENTION

1. Field of the Invention

The present invention relates to an image synthesizing method and a control method of a digital camera which obtains an image through visible and invisible lights.

2. Description of the Related Art

In this specification of the present patent application, the entire recitations of the Japanese Patent Application No. 2008-273018 filed on Oct. 23, 2008, including its specification, drawings and Scope of Claims, are incorporated by reference.

An invisible light image which is obtained through exposure to invisible light is different to what one actually sees through his eyes, and therefore does not become, most cases, a photo shooting target of a still camera (silver salt camera). However, cameras which can image an object through exposure to visible and invisible lights have been conventionally devised. In these cameras, visible light data is used mostly to enhance the recognition of a photographic subject in the invisible light image, and the photographic subject in the invisible light image can be more accurately detected referring to the visible light data.

A view that a memory color should be more emphasized in a photograph has recently become popular, and accordingly such an arresting image that can be remembered long is increasingly demanded rather than what one actually sees. For example, a mountain range far in the distance is blurrily and unclearly imaged by a conventional visible light imaging camera, and such a mountain range is also unclear and blurred to the human eye. However, when one sees a beautiful landscape, for example, the landscape, even if it is a mountain range far off, is printed on his memory as if he saw it clearly. On the other hand, a camera capable of taking an image of a near-infrared light region (invisible light imaging camera) can clearly capture such a distant mountain range. The advantage of the camera is utilized as follows: the blurred mountain range is photographed by an imaging camera adaptable to both the near-infrared light region and the visible light region, and the two images obtained in the near-infrared light region and the visible light region are synthesized, whereby a photograph which clearly represents the distant mountain range can be produced. An example of the technology is recited in a disclosed Japanese Patent Document (H11-143031 of the Japanese Patent Applications Laid-Open).

However, the near-infrared light image (invisible light image) is different to the image obtained through exposure to the visible light. Therefore, a synthesis ratio and synthesis conditions used when the two images are synthesized cannot be easily determined. Further, a memory color varies since each individual feels differently, and therefore an optimal synthetic image varies among individuals.

The conventional example refers to an image synthesis technology for a silver salt camera, wherein a person of a maker in charge of synthesis adjustment adjusts how to synthesize images for the creation of a synthetic image (photograph), for example, in course of manufacture, by changing synthesis coefficients with reference to information on R, G and B. However, in that case, it is difficult for a user to make adjustment because the correction conditions (synthesis coefficient) are fixed. Therefore, it is difficult to obtain an optimal synthetic picture which meets all of the conditions or a synthetic picture which is the most desirable for everyone.

Software applications for processing digital images are now available. Therefore, images digitally stored can be synthesized by the software in the same manner as described earlier. However, since video components which cannot be visually confirmed through the visible light are scattered in an image obtained through exposure to light including the invisible light, it is quite difficult to process the stored images while visually confirming the image on a display. Under the circumstances, it is necessary to synthesize images under the most suitable conditions and then digitally store video signals before the images are stores; however, such operations are a complicated process which could only be implemented by an expert in the field.

### SUMMARY OF THE INVENTION

According to the present invention, advantages of a digital camera, which are easiness of digital processing and image display on its monitor, are utilized to correct and synthesize images, and synthesis conditions are determined based on not only information of R, G and B but also correlation information of peripheral pixels made available through digital filtering or the like. Further, an even more distinct image can be obtained by correcting a gain or the like in addition to the synthesis conditions. Before images are recorded, the R, G and B information are corrected, and a brightness signal and a color difference signal are independently arbitrarily changed according to external parameters while the images are being displayed on the monitor, so that the synthesis conditions and correction conditions are optimally adjusted in accordance with each scene. As a result, an image which is the most suitable for a scene or an image which is considered optimal by a viewer can be obtained.

A digital camera according to the present invention comprises:

a generator for generating a visible light video signal by receiving visible light and generating an invisible light video signal by receiving invisible light;

a synthesizer for synthesizing the visible light video signal and the invisible light video signal in such a manner that a synthesis ratio can be changed;

an adjuster for receiving parameters relating to image synthesis inputted by an operator from outside and adjusting the synthesis ratio based on the received parameters; and

a display unit for generating a synthetic image from a synthetic video signal obtained by the synthesizer and displaying the synthetic image, wherein

the parameters inputted to the adjuster by the operator are received and the synthesis ratio is changed by the adjuster based on the received parameters while the synthetic image is being displayed by the display unit.

According to the present invention thus constituted, the parameters can be independently arbitrarily changed, and synthesis conditions and correction conditions can be adjusted to create optimal conditions in accordance with a scene. As a result, an image most suitable for each scene and photographic subject can be obtained by the digital camera alone.

According to a preferable mode of the present invention, each of the parameters is a coefficient relating to a video signal set in the synthetic video signal in accordance with the synthesis ratio, and the adjuster comprises:

a first controller for previously setting and storing therein the coefficient in accordance with photographing situations and then receiving selective operations relating to the photographing situation by the operator, the first controller further setting a standard value of the synthesis ratio conformable to the received selected situation based on the coefficient corresponding to the received selected situation;

a second controller for receiving input operations relating to the coefficient by the operator while checking the synthetic image generated by the synthesizer based on the standard value of the synthesis ratio set by the first controller and displayed by the display unit, and adjusting the coefficient to a higher value based on the received input operation; and

a third controller for receiving the input operation relating to the coefficient by the operator while checking the synthetic image generated by the synthesizer based on the standard value of the synthesis ratio set by the first controller and displayed by the display unit and adjusting the coefficient to a lower value based on the received input operation.

Thus constituted, the parameters can be adjusted more easily.

According to another preferable mode of the present invention, the adjuster previously stores therein a first parameter standard value representing the 100% visible light video signal (the 0% invisible light video signal) and a second parameter standard value representing the 100% invisible light video signal (the 0% visible light video signal), and switches between the first parameter standard value and the second parameter standard value, so that the digital camera is selectively used as a visible light imaging camera and an invisible light imaging camera. Accordingly, the digital camera can serve as a visible light imaging camera at some times and an invisible light imaging camera at the other times.

According to still another preferable mode of the present invention, the invisible light video signal is a near-infrared light video signal, and the synthesizer changes the synthesis ratio between the visible light video signal and the near-infrared video signal based on the parameters inputted to the adjuster by the operator in accordance with on color component levels in the synthetic image displayed by the display unit. Accordingly, the video signal which corrects and improves an image under certain conditions, for example, a blurred image, can be obtained.

According to still another preferable mode of the present invention, the generator comprises:

a single image sensor comprising a plurality of pixels for generating the visible light video signal by receiving visible light and generating the invisible light video signal by receiving invisible light; and

a filter circuit for generating an R signal, a G signal, a B signal, a visible light brightness signal and an invisible light signal corresponding to each of the pixels of the image sensor by filtering the visible light video signal and the invisible light video signal outputted from each of the pixels, wherein

the synthesizer synthesizes the R signal, the G signal, the B signal, the visible light brightness signal and the invisible light signal outputted from the filter circuit. As a result, the camera can have a downsized structure.

According to still another preferable mode of the present invention, the generator comprises:

a visible light image sensor comprising a plurality of pixels for generating the visible light video signal by receiving visible light;

an invisible light image sensor comprising a plurality of pixels for generating the invisible light video signal by receiving invisible light;

a visible light filter circuit for generating an R signal, a G signal, a B signal and a visible light brightness signal corresponding to each of the pixels of the visible light image sensor by filtering the visible light video signal outputted from each of the pixels; and

an invisible light filter circuit for generating an invisible light signal corresponding to each of the pixels of the invisible light image sensor by filtering the invisible light video signal outputted from the each of the pixels, wherein

the synthesize synthesizes the R signal, the G signal, the B signal and the visible light brightness signal outputted from the visible light filter circuit and the invisible light signal outputted from the invisible light filter circuit. The digital camera thus constituted can improve its accuracy and resolution.

According to still another preferable mode of the present invention, the digital camera further comprises:

a visible light high-pass filter for extracting a high-frequency component of the visible light video signal;

an invisible light high-pass filter for extracting a high-frequency component of the invisible light video signal;

a selector for comparing a signal level of the high-frequency component of the visible light video signal extracted by the visible light high-pass filter and a signal level of the high-frequency component of the invisible light video signal extracted by the invisible light high-pass filter and selecting one of the high-frequency component of the visible light video signal and the high-frequency component of the invisible light video signal based on the comparison result; and

an adder for adding the high-frequency component selected by the selector to the synthetic video signal outputted by the synthesizer. Accordingly, an image having an improved resolution can be obtained.

According to still another preferable mode of the present invention, the generator generates the visible light video signal with the R signal and the G signal included, and the adjuster separately changes a signal level of the R signal and a signal level of the B signal based on the adjusted synthesis ratio. Accordingly, color reproduction of the synthetic image can be improved.

According to still another preferable mode of the present invention, the adjuster changes a signal level of each color in the synthetic video signal based on the adjusted synthesis ratio. Accordingly, an image with more vivid colors can be obtained.

According to still another preferable mode of the present invention, the display unit generates and displays a synthesis ratio indicating image having such a gray level that corresponds to the synthesis ratio. Accordingly, the synthesis ratio can be visually confirmed, and the parameter can be thereby adjusted more easily and accurately.

According to the present invention so far described, a synthetic image in a natural state which appears as if a part which is actually invisible was caught by eyes can be obtained, and a synthetic image which meets photographing conditions and users' preferences can be obtained.

The method of synthesizing a visible light signal and invisible light signal and the control method according to the present invention are useful to a digital camera for imaging an object while checking a monitor.

### BRIEF DESCRIPTION OF THE DRAWINGS

These and other objects of the invention will become clear by the following description of preferred embodiments of the invention and be specified in the claimes attached hereto. A number of benefits not recited in this specification will come to the attention of the skilled in the art upon the implementation of the present invention.

FIG. 1 is an illustration of a constitution according to the present invention.

FIG. 2 is an illustration of a constitution of a camera signal processing circuit.

FIG. 3 is an illustration of a constitution of a camera signal processing circuit (two sensors are provided).

FIG. 4 is an illustration of a constitution of a condition determining circuit.

FIG. 5 is an illustration of a constitution of a correction coefficient calculator.

FIG. 6 is an illustration of a constitution of a brightness signal processing circuit.

FIG. 7 is an illustration of a constitution of a color difference signal processing circuit.

FIG. 8 is an illustration of a pixel array in a sensor adaptable to both visible and invisible lights.

FIG. 9 is an illustration of a pixel array in a visible light sensor.

FIG. 10 is an illustration of a pixel array in a near-infrared light sensor.

FIG. 11 is a CPU control flow chart.

FIG. 12 is an illustration of a constitution of the camera signal processing circuit provided with additional functions.

FIG. 13 is an illustration of the constitution according to the present invention provided with additional functions.

### DETAILED DESCRIPTION OF THE INVENTION

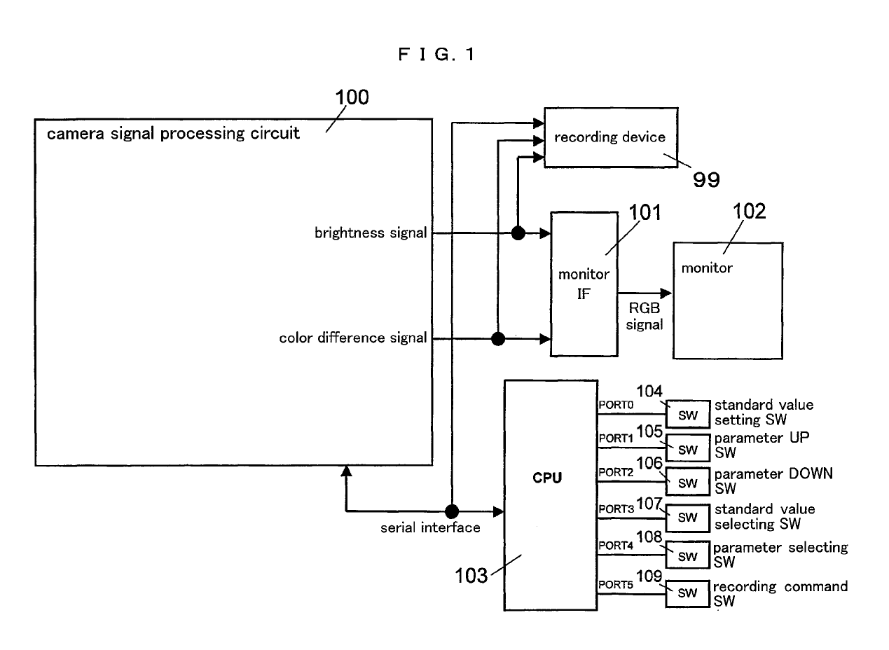

In FIG. 1, a constitution of a digital camera according to a preferred embodiment of the present invention is illustrated. In the digital camera according to the present preferred embodiment, a camera signal processing circuit 100 outputs a brightness signal and a color difference signal as digital video signals to a monitor IF circuit 101. The monitor IF circuit 101 generates video signals by converting the brightness signal and the color difference signal into video signals for monitoring, and outputs the generated video signals to a monitor 102. At the same time, the camera signal processing circuit 100 outputs data (brightness signal and color difference signal) to a recording device 99.

A CPU 103 is connected to the camera signal processing circuit 100 and the recording device 99 by way of a serial interface or the like and thereby controls the camera signal processing circuit 100. Each of general-purpose ports of the CPU 103 is connected to a standard value setting SW 104, a parameter UP SW 105, a parameter DOWN SW 106, a standard value selecting SW 107, a parameter selecting SW 108, and a recording command SW 109.

The camera signal processing circuit 100 comprises a synthesizer for synthesizing an invisible light image and a visible light image with a synthesis ratio changeable from outside. The CPU 103 and the SWs 104-108 constitute an adjuster for controlling the synthesis ratio of the images from outside. The monitor 102 constitutes a display unit which monitors the images. The SWs 104-108 constitute a first controller for deciding a recommended value, a second controller for arbitrarily increasing a coefficient, and a third controller for arbitrarily reducing the coefficient.

An operator controls the SWs 104-108 while confirming the images displayed on the monitor 102 based on the video signals and thereby controls parameters. When optimal parameters to be set are determined, the operator turns on the recording command SW 109 (corresponding to pressing a shutter), and images are thereby recorded in an optimal state. The parameters are controlled (adjusted) when the CPU 103 connected to the SWs 104-108 confirms the states of the SWs 104-108 adjusted by the operator and then controls the camera signal processing circuit 100 and the recording device 99 depending on the confirmed states of the SWs 104-108.

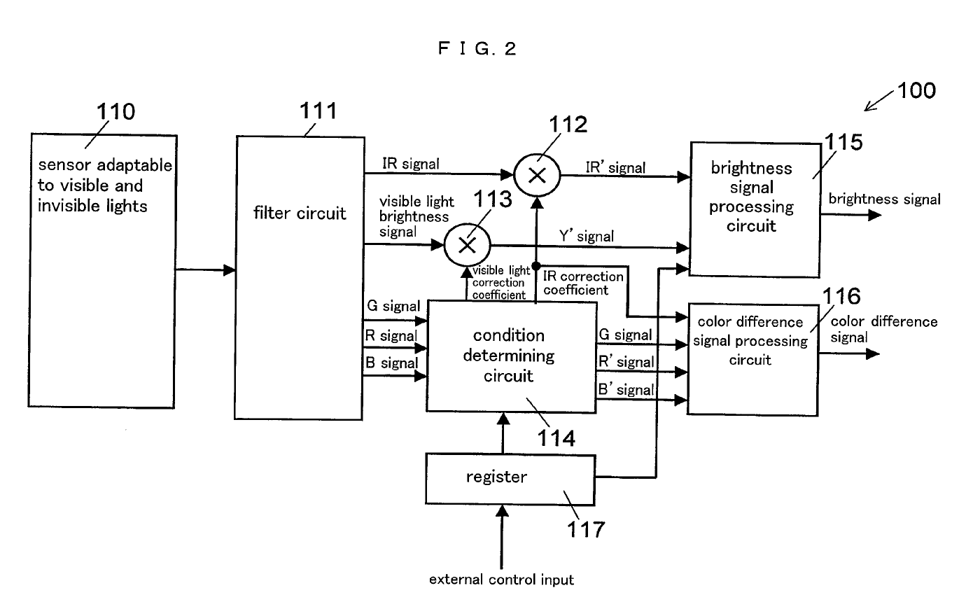

An overall operation is specifically described below. First, an operation of the camera signal processing circuit 100 is described. FIG. 2 illustrates a constitution of the camera signal processing circuit 100 in which a sensor adaptable to both visible and invisible lights is used as a generator. The camera signal processing circuit 100 comprises a sensor 110 adaptable to both visible and invisible lights, a filter circuit 111, multipliers 112 and 113, a condition determining circuit 114, a brightness signal processing circuit 115, a color difference signal processing circuit 116, and a register 117.

In an example described below, wherein a near-infrared light image obtained through exposure to near-infrared ray (IR) is used as an invisible light image, the invisible light (near-infrared ray) image and a visible light image are synthesized in order to change the visible light image whose distant object is blurred to a vivid image.

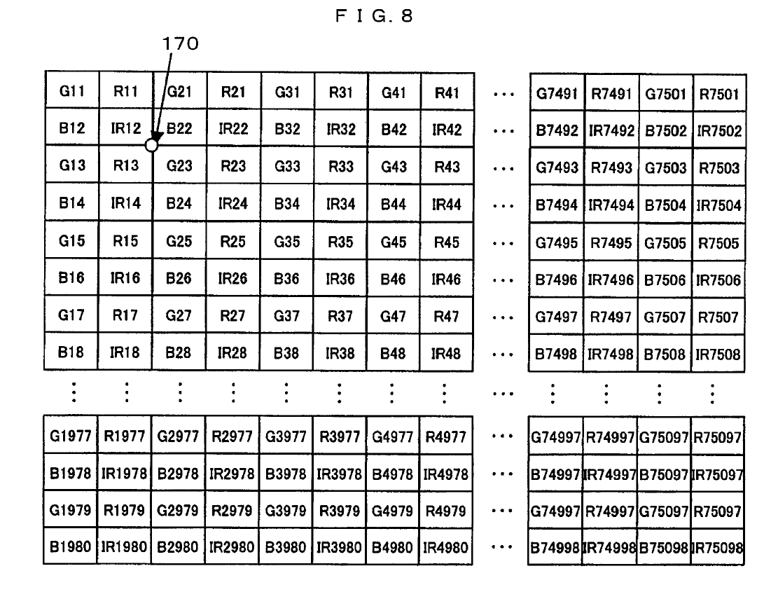

A single image sensor which receives visible and invisible lights (sensor 110 adaptable to both visible and invisible lights) comprises R pixels, G pixels, B pixels and invisible light pixels as illustrated in FIG. 8, and IR pixels illustrated therein are the invisible light pixels. A description is given below referring to an example in which a sensor having the pixel array illustrated in FIG. 8 is used.

A video signal outputted from the sensor 100 adaptable to visible and invisible lights is supplied to the filter circuit 111. Each of the video signals supplied to the filter circuit 111, which corresponds to one pixel, has only one piece of pixel information indicating one of the R pixel, G pixel, B pixel and IR pixel. Therefore, the filter circuit 111 filters the video signals by providing a coefficient to each of the video signals such that a centroid of each pixel corresponds to that of a peripheral pixel of the same color. Accordingly, the filter circuit 111 generates the R signal, G signal, B signal, IR signal and visible light brightness signal for each of the pixels. Below is given a filtering example for generating the R signal, G signal, B signal, IR signal and visible light brightness signal in a pixel 170 illustrated in FIG. 8.

G1=(G11+(3*G21)+(3*G12)+(9*G22))/16

R1=((3*R11)+R21+(9*R13)+(3*R23)) /16

B1=((3*B12)+(9*B22)+B14+(3*B24))/16

Y1=(0.69*G1)+(0.3*R1)+(0.11*B1)

IR1=((9*IR12)+(3*IR22)+IR24+(3*IR14))/16

The filter circuit 111 generates the R signal, G signal, B signal, IR signal and visible light brightness signal for one pixel. Of the signals generated by the filter circuit 111, the R signal, G signal and B signal are supplied to the condition determining circuit 114.

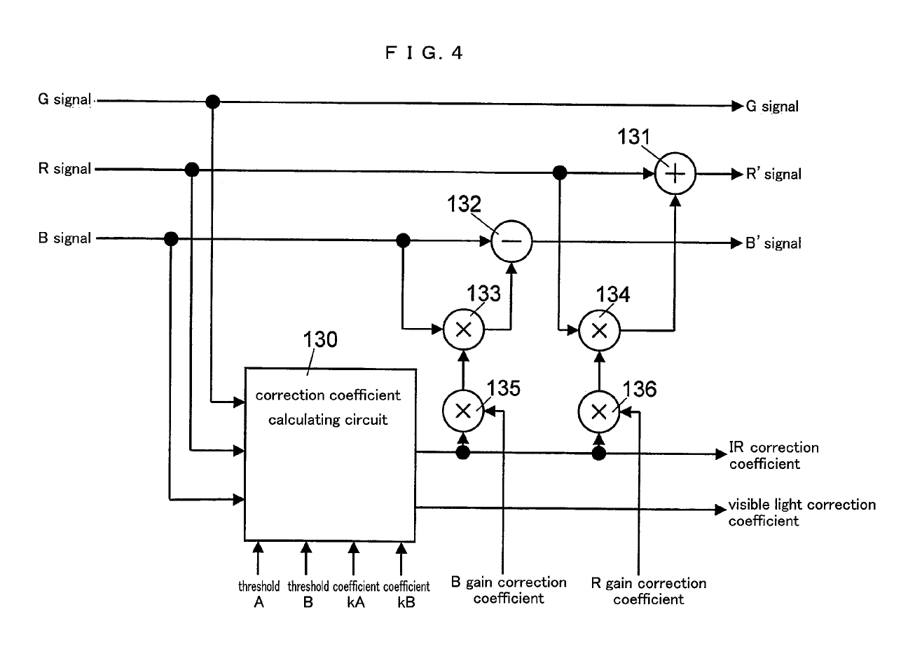

FIG. 4. illustrates a constitution of the condition determining circuit 114. The condition determining circuit 114 comprises a correction coefficient calculating circuit 130, an adder 131, a subtractor 132, and multipliers 133, 134, 135 and 136. The correction coefficient calculating circuit 130 calculates an IR correction coefficient and a visible light correction coefficient used for deciding a synthesis ratio between the visible light signal and the IR signal based on the supplied R signal, G signal, B signal and IR signal.

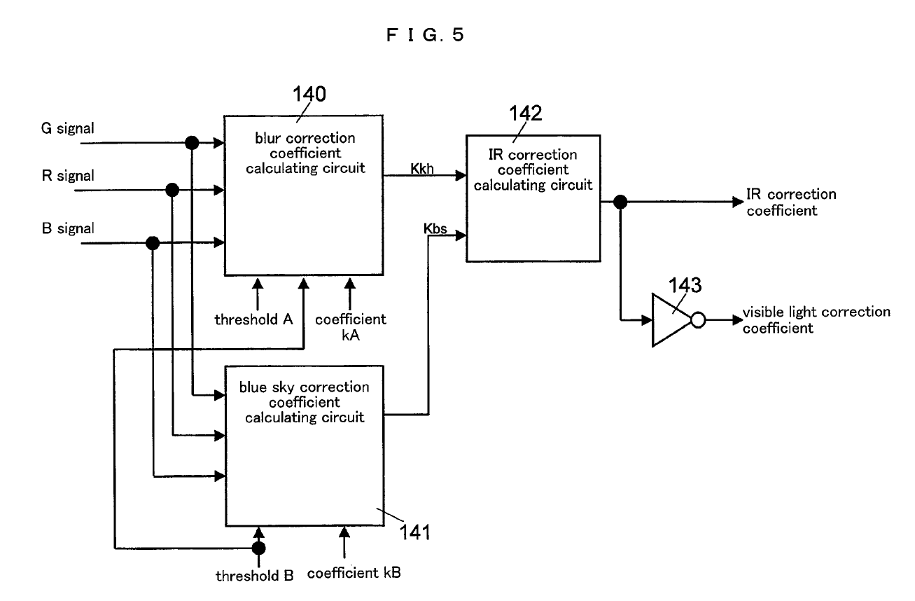

FIG. 5 illustrates a constitution of the correction coefficient calculating circuit 130. Referring to FIG. 5, the calculation of the IR correction coefficient and the visible light correction coefficient by the correction coefficient calculating circuit 130 is described. The correction coefficient calculating circuit 130 comprises a blur correction coefficient calculating circuit 140, a blue sky correction coefficient calculating 141, an IR correction coefficient calculating circuit 142, and an inverter 143. In this description, the characteristics of near-infrared ray are utilized to calculate the IR correction coefficient and the visible light correction coefficient.

In the range of a visible light wavelength, light is more easily scattered by molecules constituting the atmosphere as the wavelength of the light is shorter. Therefore, a blurred object in the distance tends to look bluish (imaged as a bluish object). Because a near-infrared ray is less scattered by the molecules constituting the atmosphere than visible light, a distant object can be pictured without a blur in an image obtained through exposure to the near-infrared ray. Utilizing the advantage, a portion which looks bluish is extracted and the video signal of the IR signal component is synthesized with the bluish part by a higher ratio. As a result, a clear picture in which even a distant object is not blurred can be obtained. The blur correction coefficient calculating circuit 140 is a circuit for calculating a blur correction coefficient.

On the contrary, in a near-infrared light image in which a blue sky is pictured, the light absorption often makes the obtained image look darkish (imaged as a darkish object). Therefore, when the IR signal component is increased in the near-infrared light image in which a blue sky is pictured, the sky looks dusky in the image. Accordingly, it is necessary to increase a signal component of the visible light in a photograph including a blue sky. The blue sky correction coefficient calculating circuit 141 is a circuit for calculating a blue sky correction coefficient in a picture including a blue sky.

Below is described an example of the calculation of a blur correction coefficient by the blur correction coefficient calculating circuit 140. In order to extract a part which looks bluish, the blur correction coefficient calculating circuit 140 focuses on a color difference signal B−R, and distinguishes the bluish part from other parts based on a size of the color difference signal B−R. In order to distinguish these parts in this way, a threshold A for determining a bluish level, a threshold B for determining a blue level of a blue sky and a coefficient kA for adjusting a synthesis ratio are supplied to the blur correction coefficient calculating circuit 140 from the register 117.

Comparing the blur component and the blue sky in terms of the color difference signal B−R, the blur component<blue sky, therefore, it is necessary to set threshold A<threshold B. The conditions for a blur correction coefficient Kkh are as follows when the thresholds A and B are set within the range of 0-255, and data of R and B is data falling within the range of 0-255.

When threshold A=0, Kkh=100. When threshold B>(B−R)>threshold A, Kkh=kA ((B−R)−threshold A). When (B−R)>threshold B, Kkh=threshold B−threshold A. When (B−R)≦threshold A, Kkh=0.

When the blur correction coefficient Kkh is calculated under the foregoing conditions, the following analyses are given: the blur correction coefficient Kkh increases along the tilt of the coefficient kA in proportion to the color difference signal B−R in the case of threshold A≦color difference signal B−R<threshold B; and the image represents the blue sky in the case of threshold B≦color difference signal B−R.

When the blue sky is corrected, it is necessary to reduce the blur correction coefficient Kkh in the IR signal component. Accordingly, the blur correction coefficient Kkh is retained within the range of threshold B<Kkh<threshold A. The blue sky correction coefficient in this case is generated by the blue sky correction coefficient calculating circuit 141.

The threshold A can be set to “0” (Min value) or “255” (Max value) in order to make the blur correction coefficient Kkh 0% or 100%, respectively. Accordingly, the blur correction coefficient Kkh can be unconditionally set to 100% (threshold A=“0”) or 0% (threshold A=“255”).

Next, an example of the calculation of a blue sky correction coefficient by the blue sky correction coefficient calculating circuit 141 is described. In the blue sky correction, the color difference signal B−R is brought into focus as in the case of the blur correction, and the correction is determined based on the size of the color difference signal B−R. In order to determine the blue level, the threshold value B and a coefficient for adjusting the synthesis ratio are supplied to the blue sky correction coefficient calculating circuit 141 from the register 117.

Comparing the blur component and a blue sky in terms of the size of the color difference signal B−R, the blur component<blue sky; therefore, it is necessary to set threshold A<threshold B. Accordingly, the conditions for a blue sky correction coefficient Kbs are as follows when the threshold value B is set within the range of 0-255, and the data of R and B are set within the range of 0-255.

When (B−R)>threshold B, Kbs=kB ((B−R)−threshold B). When (B−R)≦B, Kbs=“0.”

When the blue sky correction coefficient Kbs is calculated under the foregoing conditions, the blue sky correction coefficient Kbs increases along the tilt of the coefficient kB in proportion to the color difference signal B−R in the case of the color difference signal B−R threshold B.

When the threshold B is set to “255,” the blue sky correction coefficient Kbs can be made 0%. More specifically, the blue sky correction coefficient Kbs can be unconditionally set to 100% (threshold A=“0”) or 0% (threshold A=“255”) (Max value), and the threshold B=“255” (Max value) when the threshold B=“0” (Min value), the threshold A=“255” (Max value) or the threshold B=“255” (Max value) is set.

The thresholds A and B and the coefficients kA and kB supplied from the register in the foregoing description can be set in the correction coefficient calculating circuits 140 and 141 from outside by way of the register 117. Therefore, the wavelength region detected as the IR signal component can be changed when the thresholds A and B are changed, and the synthesis ratio used when the IR signal component is synthesized can be changed when the coefficients kA and kB are changed.

The blur correction coefficient of the blur correction coefficient calculating circuit 140 and the blue sky correction coefficient of the blue sky correction coefficient calculating circuit 141 calculated as described so far are supplied to the IR correction coefficient calculating circuit 142. The IR correction coefficient calculating circuit 142 compares the blur correction coefficient Kkh and the blue sky correction coefficient Kbs supplied thereto to figure out which of them is larger or smaller than the other. The IR correction coefficient calculating circuit 142 subtracts the blue sky correction coefficient Kbs from the blur correction coefficient Kkh (Kkh−Kbs) when Kkh>Kbs to thereby generate the IR correction coefficient.

When the IR correction coefficient is thus generated, the IR correction coefficient increases along the tilt of the coefficient kA in proportion to the color differenced signal B−R in order to correct the blur in the case of threshold A≦color difference signal B−R<threshold B.

In the case of color difference signal B−R≧threshold B, it is determined that the image represents a blue sky. When the blue sky is corrected, the IR correction coefficient decreases along the tilt of the coefficient kB in inverse proportion to the color difference signal B−R.

The operation conditions of an IR correction coefficient Kir1 are as follows.

In the case of Kkh>Kbs, Kir1=Kkh−Kbs. In the case of Kkh≦Kbs, Kir1=“0.”

The IR correction coefficient Kir1 generated by the IR correction coefficient calculating circuit 142 is outputted outside and also supplied to the inverter 143. The inverter 143 generates the inverse number of the IR correction coefficient Kir1 and outputs the generated inverse number as a visible light correction coefficient Kir1′. The visible light correction coefficient Kir1′ is a correction coefficient of the visible light signal, and a relationship between the visible light correction coefficient Kir1′ and the IR correction coefficient Kir1 is represented by Kir1′+Kir1=1.

The visible light correction coefficient and the IR correction coefficient outputted from the correction coefficient calculating circuit 130 are outputted outside. Further, the IR correction coefficient is supplied to the multiplier 135 provided for correcting a gain of the B signal and the multiplier 136 provided for correcting a gain of the R signal.

In the present preferred embodiment, the near-infrared ray is selectively used as the invisible light in order to correct a part blurred by the visible light. As described earlier, the visible light is characterized by its tendency to make a blurred distant landscape bluish. Therefore, an image portion where the IR correction coefficient is set to a large value looks bluish in the visible light, and tends to have a large B signal component and a small R signal component. In order to make the image portion more vivid, it is desirable that adjustment is made to reduce the B signal component and increase the gain of the R signal in the image portion. The multiplier 135 provided for generating the correction coefficient of the B signal and the multiplier 136 provided for generating the correction coefficient of the R signal are provided to calculate correction coefficients thus characterized.

The multiplier 135 provided for generating the correction coefficient of the B signal multiplies a B gain correction coefficient supplied from the register 117 by the IR correction coefficient supplied from the correction coefficient calculating circuit 130 to thereby generate a B signal correction coefficient. The multiplier 135 supplies the generated B signal correction coefficient to the multiplier 133. The multiplier 133 multiplies the B signal by the B signal correction coefficient to thereby generate a B signal correction signal. The multiplier 133 supplies the generated B signal correction signal to the subtractor 132. The subtractor 132 subtracts the B signal correction signal from the B signal to correct the B signal. The subtractor 132 outputs the correction result as a B′ signal.

The multiplier 136 for generating the correction coefficient of the R signal multiplies an R gain correction coefficient supplied from the register 117 by the IR correction coefficient to thereby generate an R signal correction coefficient. The multiplier 136 supplies the generated R signal correction coefficient to the adder 134. The multiplier 134 multiplies the R signal by the R signal correction coefficient to thereby generate an R signal correction signal. The 134 supplies the generated R signal correction signal to the adder 131. The adder 131 adds the R signal correction signal to the R signal to correct the R signal. The adder 131 outputs the correction result as an R′ signal. The G signal is directly outputted from the condition determining circuit 114 without any correction.

The B gain correction coefficient and the R gain correction coefficient supplied to the correction coefficient calculating circuit 130 can be controlled from outside by way of the register 117. When the B gain correction coefficient and the R gain correction coefficient are changed, the extent to which the correction is carried out can be adjusted.

Back to the description of the operation of the camera signal processing circuit 100, the G signal, B′ signal, and R′ signal generated by the condition determining circuit 114 are supplied to the color difference signal processing circuit 116. Similarly, the IR correction coefficient generated by the condition determining circuit 114 is supplied to the multiplier 112. The multiplier 112 multiplies the IR signal generated by the filter circuit 111 by the IR correction coefficient to thereby generate an IR′ signal. The IR′ signal generated by the multiplier 112 is supplied to the brightness signal processing circuit 115. The visible light correction coefficient generated by the condition determining circuit 114 is supplied to the multiplier 113. The multiplier 113 multiplies the visible light brightness signal generated by the filter circuit 111 by the visible light correction coefficient to thereby generate a Y′ signal, and supplies the generated Y′ signal to the brightness signal processing circuit 115.

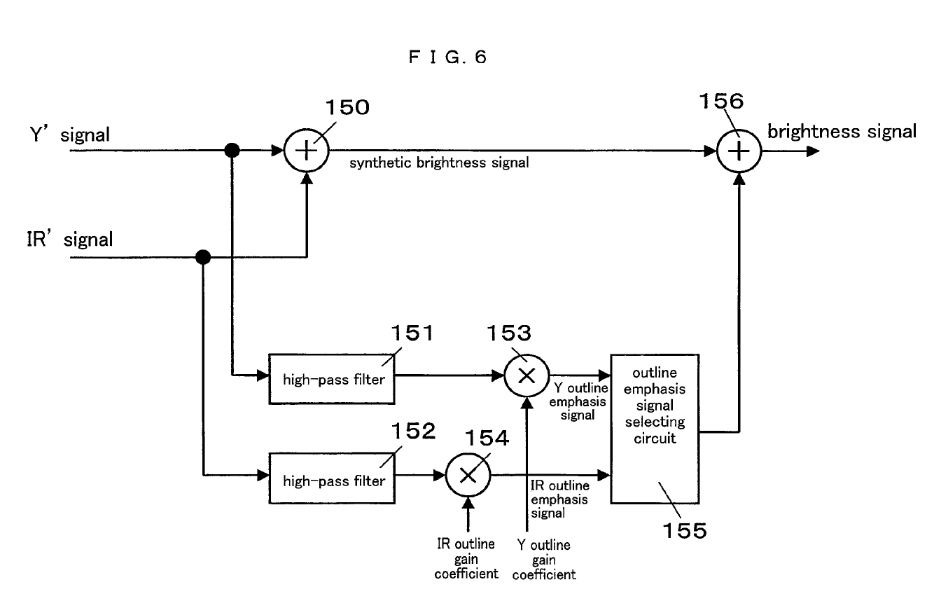

In FIG. 6, a constitution of the brightness signal processing circuit 115 is illustrated. The brightness signal processing circuit 115 comprises an adder 150, high-pass filers 151 and 152, multipliers 153 and 154, an outline emphasis signal selecting circuit 155 and an adder 156.

The Y′ signal and the IR′ signal supplied to the brightness signal processing circuit 115 are added together in the adder 150. The adder 150 supplies the addition result to the adder 156 as a synthetic brightness signal in which the IR synthesis ratio has been adjusted.

The Y′ signal and IR′ signal supplied to the brightness signal processing circuit 115 are supplied to the high-pass filter 151 and the high-pass filter 152, respectively. The high-pass filter 151 generates a Y outline extraction signal by providing an outline extracting process to the Y′ signal, while the high-pass filter 152 generates an IR outline extraction signal by providing an outline extracting process to the IR′ signal. The high-pass filter 151 supplies the generated Y outline extraction signal to the multiplier 153 for adjusting a Y outline gain, while the high-pass filter 152 supplies the generated IR outline extraction signal to the multiplier 154 for adjusting an IR outline gain. The multiplier 153 for adjusting the Y outline gain multiplies the Y outline extraction signal supplied thereto by a Y outline gain coefficient supplied from the register 117 to thereby adjust a gain of the Y outline extraction signal. As a result of the processing, the multiplier 153 for adjusting the Y outline gain generates a Y outline emphasis signal and supplies the generated Y outline emphasis signal to the outline emphasis signal selecting circuit 155. The multiplier 154 for adjusting the IR outline gain multiplies the IR outline extraction signal supplied thereto by an IR outline gain coefficient supplied from the register 117 to thereby adjust a gain of the IR outline extraction signal. As a result of the processing, the multiplier 154 for adjusting the IR outline gain generates an IR outline emphasis signal and supplies the generated IR outline emphasis signal to the outline emphasis signal selecting circuit 155.

A near-infrared ray is characterized in that green trees and plants reflect a near-infrared ray, thereby often making the contrast between light and shade more distinct. Therefore, when trees and plants are photographed, the IR outline emphasis signal>Y outline emphasis signal. Utilizing the characteristics, the IR outline emphasis signal is used as an edge emphasis signal, so that an image with an improved resolution can be obtained. The operation conditions of the outline emphasis signal selecting circuit 155 are as follows: outline emphasis signal=Y outline emphasis signal in the case of IR outline emphasis signal≦Y outline emphasis signal, and outline emphasis signal=IR outline emphasis signal in the case of the IR outline emphasis signal>Y outline emphasis signal.

However, a near-infrared ray has characteristics different to those of visible light. In an image where there are clouds in a blue sky, if the outline is carelessly emphasized, the outline may be overly emphasized due to the large contrast between the blue sky and the clouds. In order to prevent the outline from being overly emphasized, it is an effective way to extract a particular outline. In order to extract a particular outline, the R signal, B signal or G signal outputted from the filter circuit 111 is added to the operation conditions of the outline emphasis signal selecting circuit 155. For example, when it is desired to emphasize the outline of trees and plants, the G signal should be added to the conditions. When the G signal is added to the conditions, the conditions are as follows.

Outline emphasis signal=IR outline emphasis signal in the case of IR outline emphasis signal>Y outline emphasis signal and G signal>threshold G; and outline emphasis signal=Y outline emphasis signal otherwise. At this time, the threshold G is supplied from the register 117.

The Y outline emphasis signal generated by the outline emphasis signal selecting circuit 155 is supplied to the adder 156. The adder 156 adds the Y outline emphasis signal to the synthetic brightness signal generated by the adder 150 to thereby execute the outline emphasis of the synthetic brightness signal. The adder 156 outputs the outline-emphasized brightness signal. The Y outline gain coefficient and the IR outline gain coefficient supplied from the register 117 to the brightness signal processing circuit 115 can be controlled from outside by way of the register 117. Therefore, when an operator changes these Y outline gain coefficient and IR outline gain coefficient, the extent to which the outline is corrected can be adjusted.

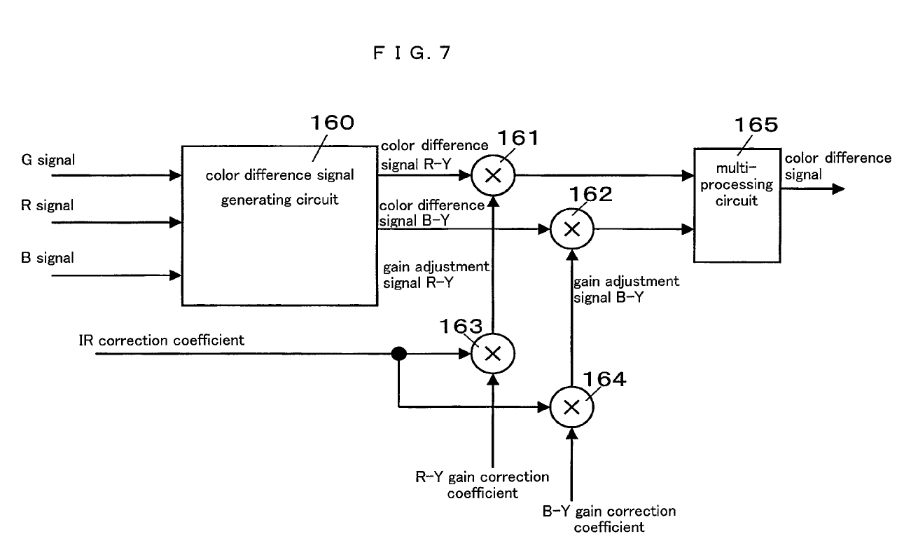

Next, an operation of the color difference signal processing circuit 116 is described referring to FIG. 7. The color difference signal processing circuit 116 is supplied with the R signal, B signal, G signal and IR coefficient signal from the condition determining circuit 114.

In FIG. 7, a constitution of the color difference signal processing circuit 116 is illustrated. The R signal, B signal and G signal supplied to the color difference signal processing circuit 116 are supplied to a color difference signal generating circuit 160. The color difference signal generating circuit 160 processes the R signal, B signal and G signal based on the following conversion formulas to thereby generate a color difference signal R-Y and a color difference signal B-Y.

### Conversion Formulas

R-Y=R−((0.59*G)+(0.3*R)+(0.11*B))

B-Y=B−((0.59*G)+(0.3*R)+(0.11*B))

The color difference signal generating circuit 160 supplies the generated color difference signals R-Y and B-Y to multipliers 161 and 162. The multiplier 161 adjusts a gain of the color difference signal R-Y, while the multiplier 162 adjusts a gain of the color difference signal B-Y. The adjustment of the gains by the multipliers 161 and 162 is variable depending on the IR coefficient. The IR coefficient herein described has a large value because it deals with the blurred video signal. The IR coefficient having a large value means a blurred signal input. In the described case, the R signal, B signal and G signal, which are the visible light signals, are supplied to the color difference signal generating circuit 160 with fewer color components included therein. Therefore, when the gains of the color difference signals R-Y and B-Y are increased depending on the dimension of the IR signal, colors can be vividly displayed.

The multiplier 163 multiplies the IR correction coefficient supplied from the correction coefficient calculating circuit 130 by an R-Y gain correction coefficient supplied from the register 117 to thereby generate a gain adjustment signal R-Y. The multiplier 164 multiplies the IR correction coefficient supplied from the correction coefficient calculating circuit 130 by a B-Y gain correction coefficient supplied from the register 117 to thereby a gain adjustment signal B-Y. When the multipliers 163 and 164 multiply the IR correction coefficient by the R-Y gain correction coefficient and the B-Y gain correction coefficient, an amount of correction of (the extent to which correction is made to) of the visible light signals (R signal, G signal and B signal) using the invisible light signal (IR signal) can be adjusted. The R-Y gain correction coefficient and the B-Y gain correction coefficient can be adjusted from outside by a user or the like by way of the register 117.

The gain adjustment signal R-Y and the gain adjustment signal B-Y respectively outputted from the multipliers 163 and 164 are supplied to the multipliers 161 and 162. The multipliers 161 and 162 are also supplied with the color difference signal R-Y and the color difference signal B-Y from the color difference signal generating circuit 160. The multiplier 161 multiplies the color difference signal R-Y by the gain adjustment signal R-Y to thereby adjust a gain of the color difference signal R-Y. The color difference signal R-Y (already gain-adjusted) and the color difference signal B-Y (already gain-adjusted) outputted from the multipliers 161 and 162 are supplied to a multiprocessing circuit 165. The multiprocessing circuit 165 multi-processes the color difference signal R-Y (already gain-adjusted) and the color difference signal B-Y (already gain-adjusted) to thereby generate a final color difference signal and outputs it.

As a result of the processes described so far, the camera signal processing circuit 100 generates the brightness signal and the color difference signal and supplies the generated signals to the monitor IF circuit 101 and the recording device 99. The monitor IF 101 generates a video signal for monitoring from the brightness signal and the color difference signal supplied thereto, and supplies the generated video signal for monitoring to the monitor 102. In the case where the monitor 102 is a display device adaptable to the RGB signals, the monitor IF circuit 101 generates the RGB signals from the brightness signal and the color difference signal and outputs them to the monitor 102. As a result of the processing, the monitor 102 can always display an image based on the output of the camera signal processing circuit 100 (brightness signal and color difference signal).

The recording device 99, when it receives a recording command from the CPU 103 by way of the serial interface, records the brightness signal and the color difference signal supplied from the camera signal processing circuit 100 on a recording medium (not shown).

The general-purpose ports of the CPU 103 are connected to the standard value setting SW 104, parameter UP SW 105, parameter DOWN SW 106, standard value selecting SW 107, parameter selecting SW 108, and recording command SW 109. The SWs 104-109 generally have outputs of “L” level and turns to “H” level only when the user operates the SWs 104-109. The SWs 104-109 are directly linked with buttons provided on an outer surface of the digital camera (or separately provided). When the user pushes the buttons, the SWs 104-109 are turned on. Accordingly, the camera signal processing circuit 100 can be arbitrarily controlled.

Next, an operation of the CPU 103 is described. The CPU 103 accesses the register 117 of the camera signal processing circuit 100 depending on the states of the general-purpose ports to thereby change the parameters of the digital camera, and at the same time, transmit the recording command to the recording device 99, so that the image recording operation is controlled.

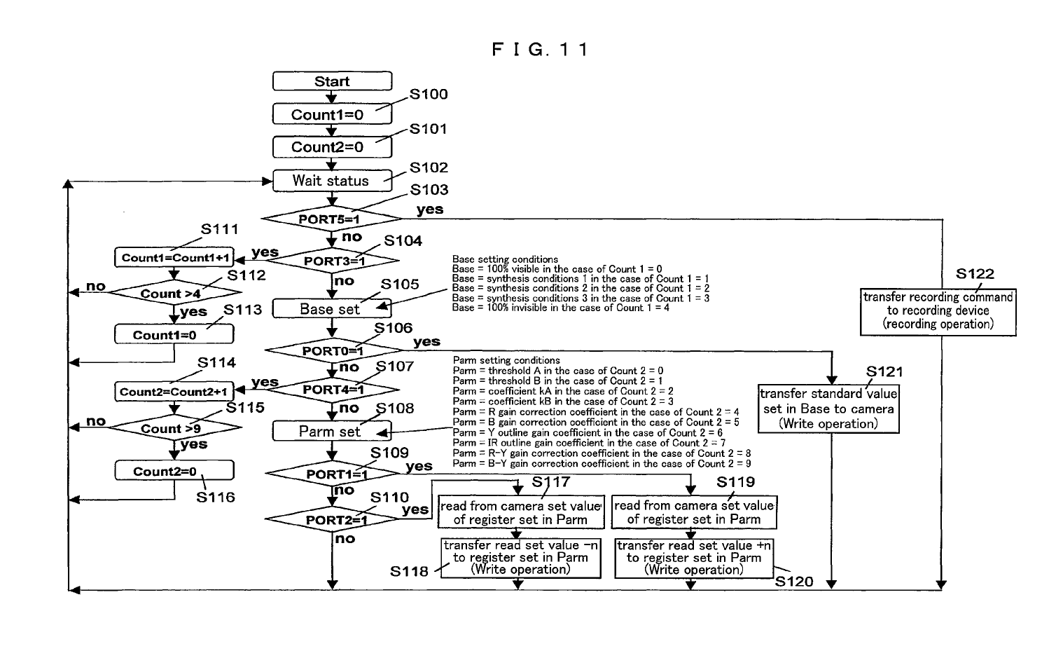

FIG. 11 is an illustration of a CPU control flow chart. When the control operation starts, Count 1=0 is set in Step S100, and Count 2=0 is set in Step S101. The Count 1 serves as a status counter which manages a combination state of the standard values. The Count 2 serves as a status counter which manages which of the parameters of the camera signal processing circuit should be accessed.

In Step S102, the general-purpose ports are monitored, and set to Wait state. The Wait state in Step S102 ends when any of PORTs 0-5 changes, and the operation advances to Step S103.

In Step S103, the state of the PORT 5 is checked. When it is confirmed in Step S103 that the state of the PORT 5 is “1,” the operation advances to Step S122. In Step S122, the recording command is transmitted to the recording device 99. The recording device 99, upon receipt of the recording command from the CPU 103 by way of the serial interface, records the camera video signals (brightness signal and color difference signal) supplied from the camera signal processing circuit 100 on the recording medium. In this stage of the operation, a timing by which the recording command SW 109 is turned on is a timing by which the shutter of the digital camera is pressed.

When it is confirmed in Step S103 that the state of the PORT 5 is “0,” the operation advances to Step the S104. In Step S104, the state of PORT 3 is checked. When it is confirmed in Step S104 that the state of the PORT 3 is “1,” the operation advances to Step S111. The PORT 3 being “1” denotes that the standard value selecting SW 107 was pressed and then turned on. When it is confirmed that the state of the PORT 3 is “1,” the operation advances to Step the S111. In Step S111, the value of the Count 1 is incremented by one. The incremented value of the Count 1 is checked in Step S112 if Count>“4.” When it is judged in Step S112 that Count is not >“4” (Count “4”), the operation returns to Step S102. When the operation is thus repeated in the order of Step→S102→Step S103→Step→S104→Step S111→Step S112→Step S102, the value of the Count 1 can be serially changed from “0” through “4.”

When it is judged in Step S112 that Count 1>“4,” the operation advances to Step S103. In Step S113, the value of the Count 1 is reset to “0.” Thus, while the standard value selecting SW 107 is operated, the value of the Count 1 is repeatedly changed from “0” through “4.”

When it is confirmed in Step S104 that the state of the PORT 3 is “0,” the operation advances to Step S105. In Step S105, the state of Base is set based on the conditions of the Count 1. The Base denotes the combination of the parameters for setting standard values. Any arbitrary values combinations can be used to execute the conditions of the Base. In the present example herein described, the operation is described referring to the following five conditions.

### Base Setting Conditions

Base=100% visible in the case of Count 1=“0”
Base=synthesis conditions 1 in the case of Count 1=“1”
Base=synthesis conditions 2 in the case of Count 1=“2”
Base=100% invisible in the case of Count 1=“3” and Base=synthesis conditions 3
Base=100% invisible in the case of Count 1=“4”

An example of setting of each parameter, in the case of a setting range of each parameter being “0”-“255” and Count 1=“0” (Base=100% visible), has the following combination.
threshold A=“255”
threshold B=“255”
coefficient kA=“0”
coefficient kB=“0”
R gain correction coefficient=“0”
B gain correction coefficient=“0”
Y outline gain coefficient=“0”
IR outline gain coefficient=“0”
R-Y gain correction coefficient=“0”
B-Y gain correction coefficient=“0”
threshold A=Max value
threshold B=Max value

In the given example, the correction coefficients (blur correction coefficient and blue sky correction coefficient) are set at “0” in the blur correction coefficient calculating circuit 140 and the blue sky correction coefficient calculating circuit 141. As a result, the IR correction is not implemented, and the visible light signal is 100% outputted.

An example of setting of each parameter, in the case of Count 1=“4” (Base=100% invisible), has the following combination.
threshold A=“0”
threshold B=“255”
coefficient kA=“arbitrary value”
coefficient kB=“arbitrary value”
R gain correction coefficient=“arbitrary value”
B gain correction coefficient=“arbitrary value”
Y outline gain coefficient=“arbitrary value”
IR outline gain coefficient=“arbitrary value”
R-Y gain correction coefficient=“arbitrary value”
B-Y gain correction coefficient=“arbitrary value”
threshold A=“0”
threshold B=“255” (Max value)

In the given example, the correction coefficients (blur correction coefficient and blue sky correction coefficient) are set at “100” in the blur correction coefficient calculating circuit 140 and the blue sky correction coefficient calculating circuit 141. As a result, the IR correction is 100% implemented, and the invisible light signal is 100% outputted.

In the case of Base=synthesis conditions 1, Base=synthesis conditions 2 and Base=synthesis conditions 3, an arbitrary value previously prepared for each of the parameters is set. In order to synthesize the invisible light signal and the visible light signal, each of the parameters is set to an arbitrary intermediate value. In order to set the arbitrary values, it is desirable to evaluate each parameter in advance, and then set the parameters which seem to be the most suitable under certain conditions.

In Step S106, the state of the PORT 0 is checked. When it is confirmed that the PORT 0 is “1,” the operation advances to Step S121. The PORT 0 being “1” denotes that the standard value setting SW 104 was operated and thereby turned on. In Step S121, the set values of the parameters are transferred to the camera signal processing circuit 100 in accordance with the conditions of the Base set in Step S105.

In the case where, for example, a digital camera is selectively used as a visible light imaging camera or an invisible light imaging camera, the digital camera can be changed to an imaging camera designed specifically for invisible light under the condition of Base=100% visible and through the operation of the standard value setting SW104.

On the other hand, the digital camera can be changed to an imaging camera designed specifically for visible light under the condition of Base=100% visible and through the operation of the standard value setting SW 104. Thus, when the standard value setting SW 104 is operated while the standard state is selected by the standard value switching SW 107, the digital camera can be selectively used as an imaging camera designed specifically for invisible light or an imaging camera designed specifically for visible light.

When a visible light image and an invisible light image are synthesized, one of Base=synthesis conditions 1, Base=synthesis conditions 2 and Base=synthesis conditions 3 is selected, and the standard value setting SW 104 is then operated to set the parameters. By doing so, the digital camera can be changed to a digital camera capable of synthesizing the visible light image and the invisible light image. The values set for the parameters which are the best arbitrary values under certain conditions are not necessarily the best for a photographic subject currently being imaged. Therefore, the parameter values are desirably changed to arbitrary values, separately. Below is described a device for arbitrarily and separately changing the parameter values. In the case of the PORT 1 being “0” in Step S106, the operation advances to Step S107.

In Step S107, the state of the PORT 4 is checked. When it is confirmed that the PORT 4 is “1,” the operation advances to Step S114. The state of the PORT 4 being “1” means that the parameter selecting SW 108 was operated and then turned on. In Step S114, the value of the Count 2 is incremented by “1.” It is judged in Step 115 if Count 2>“9.” When it is judged in Step 115 that Count 2 is not >“9,” the operation returns to Step S102. When the operation is thus repeated in the order of Step S102→Step S103→Step S104→Step S105→Step S106→Step S107→Step S114→Step S115→Step S102, the value of the Count 2 can be serially changed from “0” through “9.” When it is judged in Step 115 that Count 2>“9,” the operation advances to Step S116. In Step S116, the value of the Count 2 is reset to “0.” Accordingly, by operating the parameter selecting SW108, the value of the Count 2 is repeatedly changed, serially from “0” through “9,” and then back to “0” again after “9.”

When it is judged in Step S107 that the state of the PORT 4 is “0,” the operation advances to Step S108. In Step S108, the state of Parm is set in accordance with the conditions of the Count 2. The Parm denotes a parameter selection state. Below are listed examples of the conditions of the parameter selection.

### Parm Setting Conditions

In the case of Count 2=“0,” Parm=threshold A
In the case of Count 2=“1,” Parm=threshold B
In the case of Count 2=“2,” Parm=coefficient kA
In the case of Count 2=“3,” Parm=coefficient kB
In the case of Count 2=“4,” Parm=R gain correction coefficient
In the case of Count 2=“5,” Parm=B gain correction coefficient
In the case of Count 2=“6,” Parm=Y outline gain coefficient
In the case of Count 2=“7,” Parm=IR outline gain coefficient
In the case of Count 2=“8,” Parm=R-Y gain correction coefficient
In the case of Count 2=“9,” Parm=B-Y gain correction coefficient

When the setting of the Parm is completed, the operation advances to Step S109. In Step S109, the state of the PORT 1 is checked. When it is confirmed that the PORT 1 is “1,” the operation advances to Step S119. The PORT 1 being “1” denotes that the parameter UP SW 105 was operated and then turned on. In Step S119, serial communication is made to the camera signal processing circuit 100, and a register value of the Parm parameter set in Step S108 is read. In Step S120, a value to be added n is added to the register value read in Step S119, so that the register value is updated for a new set value. Next, serial communication is made to the camera signal processing circuit 100, and the new set value obtained from the addition is written in the register 117 in which the Parm parameter set in Step S108 is stored. The value to be added n is an arbitrary value.

In the case of Parm=threshold A and the value to be added n=“2,” the register 117 in which the threshold A is stored is accessed through the serial communication, so that data of the register 117 is read. Assuming that the read data of the threshold A is “40,” “40+2=42” is obtained from the addition, and then, the register 117 in which the threshold A is stored is accessed again through the serial communication, and the new set value “42” obtained from the addition is written in the register 117 as the threshold A. Thus, when the parameter UP SW 105 is operated, the value of the parameter set in the Parm can be increased by the addition.

In Step S111, the state of the PORT 2 is checked. When it is confirmed that the PORT 2 is “1,” the operation advances to Step S117. The PORT 2 being “1” denotes that the parameter DOWN SW 106 was operated and then turned on. In Step S117, serial communication is made to the camera signal processing circuit 100, and the register value of the Parm parameter set in Step S108 is read. In Step S118, a value to be subtracted n is subtracted from the data read in Step S117 (register value of the parameter), so that the register value of the parameter is updated for a new set value. Next, serial communication is made to the camera signal processing circuit 100, and the new set value obtained from the subtraction is written in the register 117 in which the Parm parameter set in Step S108 is stored. The value to be subtracted n is an arbitrary value.

In the case of Parm=threshold B and the value to be subtracted n=“1,” the register 117 in which the threshold B is stored is accessed through serial communication, so that data of the register 117 is read. Assuming that the read data of the threshold A is “30,” “30−1=29” is obtained from the subtraction, and then, the register 117 in which the threshold B is stored is accessed again through serial communication, and the new set value “29” obtained from the subtraction is written in the register 117 as the threshold B. Thus, when the parameter DOWN SW 106 is turned on, the value of the parameter set in the Parm can be decreased by the subtraction.

Summarizing the processes described so far,
1. A standard set value of the synthesis conditions is determined by the standard value setting SW 104.
2. A parameter desired to be changed is selected by the parameter selecting SW 108.1
3. The parameter UP SW 105 or the parameter DOWN SW106 is operated to change the set value of the parameter.
4. If there are other parameters desired to be changed, the processes 1.-3. are repeated.

During operations described above, the digital camera is in an operating state, and images are constantly displayed on the monitor. Therefore, the parameters can be changed to find out the optimal conditions while the video signal is being checked on the monitor. When the optimal conditions are found, the recording command SW 109 is turned on and the shutter is then pressed, so that the images in the optimal state are recorded.

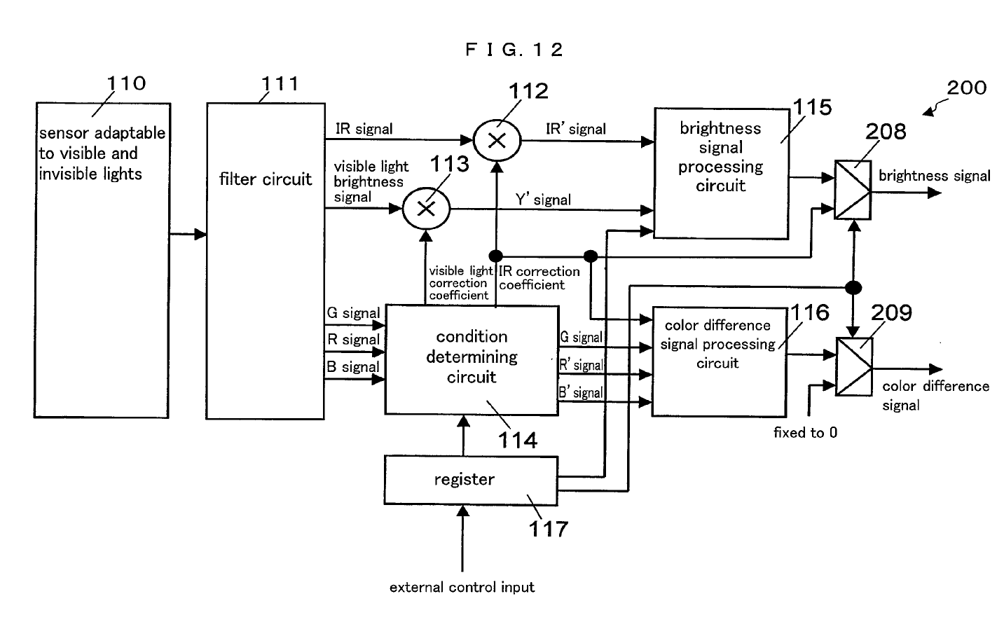

The optimal conditions are determined while the actual video signal is being checked on the monitor, and the synthesis conditions are outputted to the monitor at the same time. Thus, it can be visually confirmed what conditions are applied when the images are synthesized. FIG. 12 is an illustration of a camera signal processing circuit 200 which outputs the synthesis conditions to the monitor.

The constitution of the camera signal processing circuit 200 illustrated in FIG. 12 is basically the same as that of the camera signal processing circuit 100 illustrated in FIG. 2, and the same or similar components are illustrated with the same reference symbols attached in FIG. 2. In the constitution, a selector 208 is inserted at an output terminal of the brightness signal processing circuit 115 in the last stage, while a selector 209 is inserted at an output terminal of the color difference signal processing circuit 116. A selection signal is supplied from the register 117 to each of the selectors 208 and 209, and the selectors 208 and 209 are both thereby controllable from outside. The selector 208 selects the brightness signal outputted from the brightness signal processing circuit 115 and outputs it when the control signal is in the state of “0,” while selecting the IR correction coefficient outputted from the condition determining circuit 114 and outputting it when the control signal is in the state of “1.” The selector 209 selects the color difference signal outputted from the color difference signal processing circuit 116 and outputs it when the control signal is in the state of “0,” while selecting a fixed signal having the color component of “0” and outputting it when the control signal is in the state of “1.”

Therefore, an ordinary video signal is outputted from the camera signal processing circuit 200 when the control signal is in the state of “0.” At this time, the IR correction coefficient has a large value when the synthesis ratio of IR is high, and has a small value when the synthesis ratio of IR is low. When the IR coefficient signal is outputted as the brightness signal and displayed on the monitor, an image displayed then is black and white since the color difference signal is the fixed signal having “0”, wherein a portion of the displayed image where the IR synthesis ratio is high looks whitish, while a portion where the IR synthesis ratio is low looks dark. Accordingly, a synthesis ratio indicating image having a gray level corresponding to the synthesis ratio is displayed on the monitor 102, and the synthesis ratio can be thus visually confirmed.

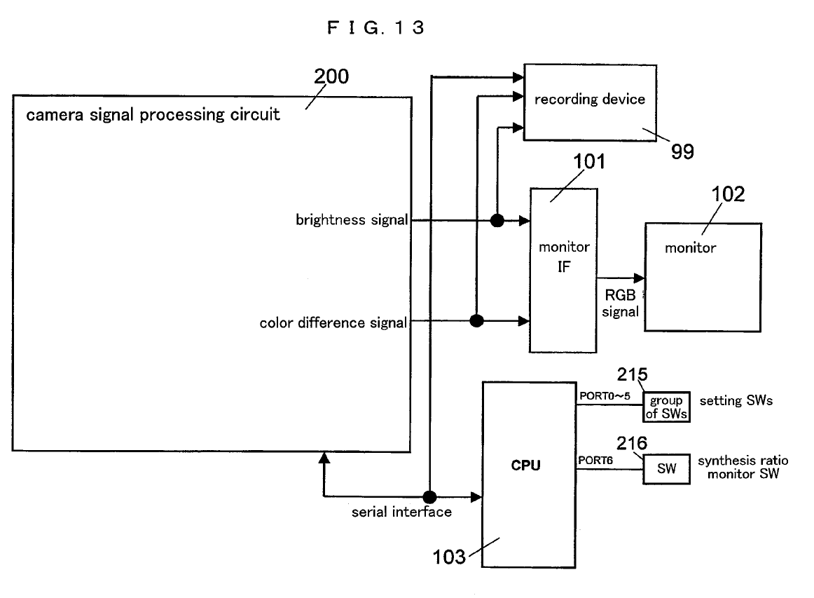

FIG. 13 is an illustration of a constitution wherein a switching operation is externally controlled. The constitution is basically the same as that of FIG. 1. In the constitution illustrated in FIG. 13, the SWs 104-109 connected to the ports of the CPU 103 in the constitution illustrated in FIG. 1 are illustrated as a group of SWs 215. A SW 216 is additionally connected to the ports of the CPU 103 as a control SW for visually confirming the synthesis ratio on the monitor 102. When the SW 216 is turned on, serial communication is made to the camera signal processing circuit 200, and the register 117 is accessed to change the control signals of the selectors 208 and 209. As a result, the outputs can be controlled.

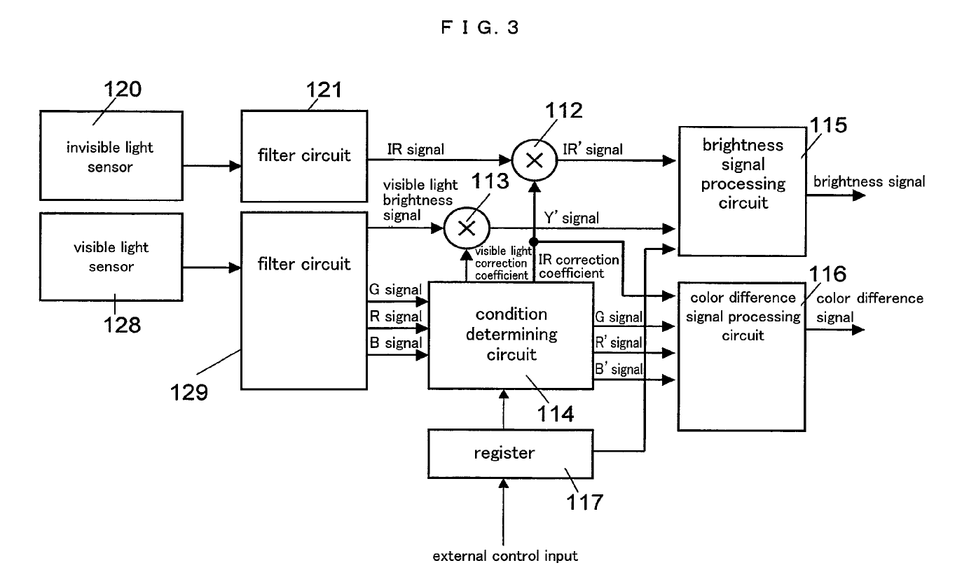

In the preferred embodiment described earlier, as illustrated in FIG. 2, the camera signal processing circuits 100 and 200 comprise a single a sensor 110 adaptable to both visible and invisible lights. As illustrated in FIG. 3, the camera signal processing circuits 100 and 200 may comprise a visible light sensor 128 and an invisible light sensor 120. In this example, a near-infrared light sensor constitutes the invisible light sensor 120.

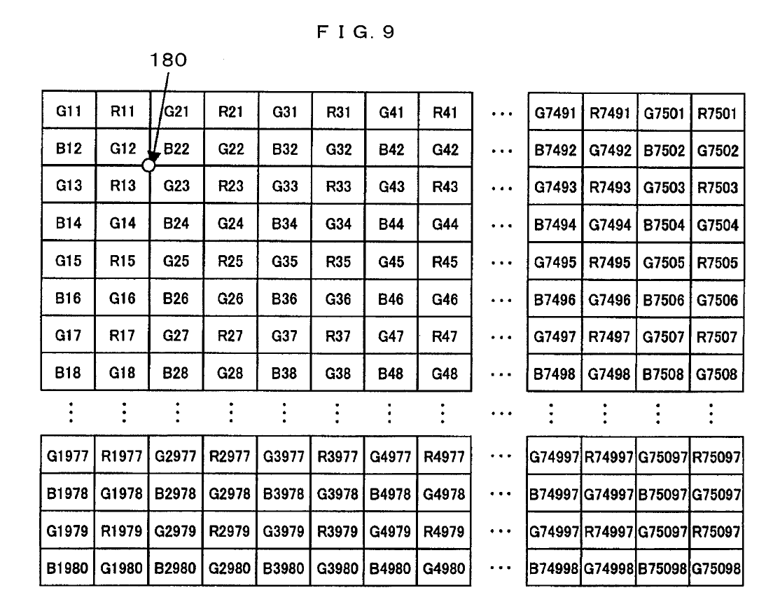

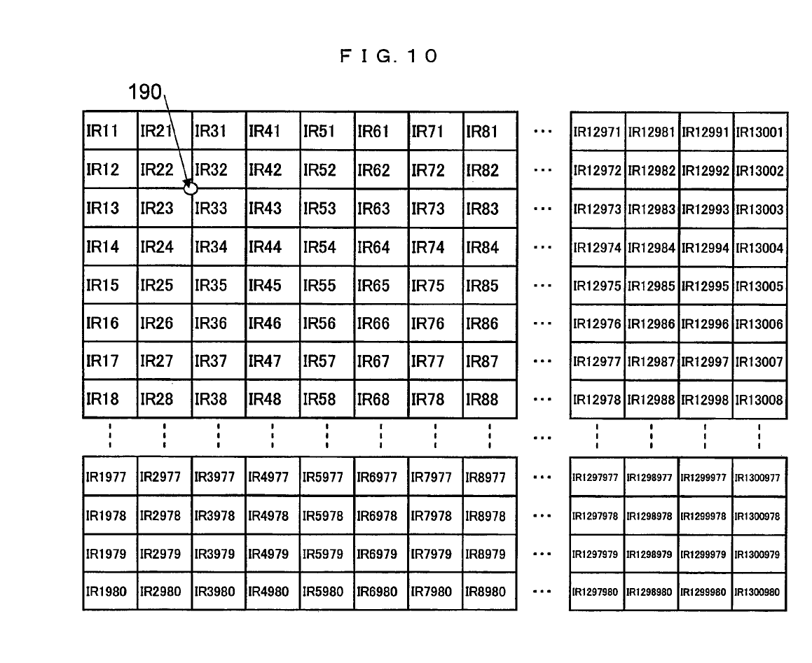

In the invisible light sensor 120, all of the pixels provided therein are IR pixels as illustrated in FIG. 10. The visible light sensor 128 has R pixels, G pixels and B pixels as illustrated in FIG. 9. An operation of the camera signal processing circuits 100, 200 provided with the sensors 120 and 128 respectively having the described pixel arrays is described below.

A video signal outputted from the visible light sensor 128 is supplied to a filter circuit 129. The video signal outputted from the visible light sensor 128 has one piece of pixel information which corresponds to one of the R pixel, G pixel and B pixel. Therefore, the filter circuit 129 filters the video signal by providing a coefficient to each video signal such that a centroid of a pixel corresponds to that of a peripheral pixel of the same color to thereby generate an R signal, a G signal, a B signal and a brightness signal for one pixel. Of the R signal, G signal, B signal and visible light brightness signal generated by the filter circuit 129, the R signal, G signal and B signal are supplied to the condition determining circuit 114, while the visible light brightness signal is supplied to the multiplier 113. A filtering example wherein the R signal, G signal, B signal and visible light brightness signal are generated for a pixel 180 illustrated in FIG. 9 is given below.

### G1=(G11+(3*G21)+(3*G12)+(9*G22))/16

### R1=((3*R11)+R21+(9*R13)+(3*R23))/16

### B1=((3*B12)+(9*B22)+B14+(3*B24))/16

### Y1=(0.69*G1)+(0.3*R1)+(0.11*B1)

The video signal outputted from the invisible light sensor 120 is supplied to the filter circuit 121. Since the invisible light sensor 120 has only an IR pixel for one pixel, the pixel centroid in the IR signal generated by the invisible light sensor 120 deviates from that of the R signal, G signal, B signal and visible light brightness signal generated by the filter circuit 129. Therefore, the filter circuit 121 filters the video signal so that the pixel centroid in the generated IR signal can correspond to that of the R signal, G signal, B signal and visible light brightness signal. An example of a filtering constitution wherein the IR signal corresponding to a pixel 190 illustrated in FIG. 10 can be generated is given below.

### IR1=(IR11+IR21+IR12+IR22)/4

The IR signal generated by the filter circuit 121 is supplied to the multiplier 112. At the time, the R signal, G signal, B signal and visible light brightness signal generated by the filter circuit 129 and the IR signal generated by the filter circuit 121 become equal to the R signal, G signal, B signal, visible light brightness signal and IR signal outputted from the filter circuit 111 which were described referring to the operation of the camera signal processing circuit 100 comprising the sensor 110 adaptable to both visible and invisible lights. Subsequent operations, therefore, can be implemented in the same way as described in the case of the camera signal processing circuit 100 comprising the sensor 110 adaptable to both visible and invisible lights.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A digital camera comprising:
a generator for generating a visible light video signal by receiving visible light and generating an invisible light video signal by receiving invisible light;
a synthesizer for synthesizing the visible light video signal and the invisible light video signal in such a manner that a synthesis ratio can be changed;
an adjuster for receiving parameters relating to image synthesis inputted by an operator from outside and adjusting the synthesis ratio based on the received parameters; and
a display unit for generating a synthetic image from a synthetic video signal obtained by the synthesizer and displaying the synthetic image, wherein
the parameters inputted to the adjuster by the operator are received and the synthesis ratio is changed by the adjuster based on the received parameters while the synthetic image is displayed by the display unit.

2. The digital camera as claimed in claim 1, wherein
Each of the parameters is a coefficient relating to a video signal set in the synthetic video signal in accordance with the synthesis ratio, and the adjuster comprises:
a first controller for previously setting and storing therein the coefficient in accordance with different photographing situations and then receiving selective operations relating to the photographing situation by the operator, the first controller further setting a standard value of the synthesis ratio conformable to the received selected situation based on the coefficient corresponding to the received selected situation;
a second controller for receiving input operations relating to the coefficient by the operator while checking the synthetic image generated by the synthesizer based on the standard value of the synthesis ratio set by the first controller and di splayed by the display unit, and adjusting the coefficient to a higher value based on the received input operation; and
a third controller for receiving input operations relating to the coefficient by the operator while checking the synthetic image generated by the synthesizer based on the standard value of the synthesis ratio set by the first controller and di splayed by the display unit, and adjusting the coefficient to a lower value based on the received input operation.

3. The digital camera as claimed in claim 1, wherein
the adjuster previously stores therein a first parameter standard value representing the 100% visible light video signal (the 0% invisible light video signal) and a second parameter standard value representing the 100% invisible light video signal (the 0% visible light video signal), and switches between the first parameter standard value and the second parameter standard value, so that the digital camera is selectively used as a visible light imaging camera and an invisible light imaging camera.

4. The digital camera as claimed in claim 1, wherein
the invisible light video signal is a near-infrared light video signal, and the synthesizer changes the synthesis ratio between the visible light video signal and the near-infrared video signal based on the parameters inputted to the adjuster by the operator in accordance with color component levels in the synthetic image displayed by the display unit.

5. The digital camera as claimed in claim 1, wherein
the generator comprises:
a single image sensor comprising a plurality of pixels for generating the visible light video signal by receiving visible light and generating the invisible light video signal by receiving invisible light; and
a filter circuit for generating an R signal, a G signal, a B signal, a visible light brightness signal and an invisible light signal corresponding to each of the pixels of the image sensor by filtering the visible light video signal and the invisible light video signal outputted from each of the pixels, wherein
the synthesizer synthesizes the R signal, the G signal, the B signal, the visible light brightness signal and the invisible light signal outputted from the filter circuit.

6. The digital camera as claimed in claim 1, wherein
the generator comprises:
a visible light image sensor comprising a plurality of pixels for generating the visible light video signal by receiving visible light;
an invisible light image sensor comprising a plurality of pixels for generating the invisible light video signal by receiving invisible light;
a visible light filter circuit for generating an R signal, a G signal, a B signal and a visible light brightness signal corresponding to each of the pixels of the visible light image sensor by filtering the visible light video signal outputted from each of the pixels; and
an invisible light filter circuit for generating an invisible light signal corresponding to each of the pixels of the invisible light image sensor by filtering the invisible light video signal outputted from the each of the pixels, wherein
the synthesize synthesizes the R signal, the G signal, the B signal and the visible light brightness signal outputted from the visible light filter circuit and the invisible light signal outputted from the invisible light filter circuit.

7. The digital camera as claimed in claim 1, further comprising:
a visible light high-pass filter for extracting a high-frequency component of the visible light video signal;
an invisible light high-pass filter for extracting a high-frequency component of the invisible light video signal;
a selector for comparing a signal level of the high-frequency component of the visible light video signal extracted by the visible light high-pass filter and a signal level of the high-frequency component of the invisible light video signal extracted by the invisible light high-pass filter and selecting one of the high-frequency component of the visible light video signal and the high-frequency component of the invisible light video signal based on the comparison result; and
an adder for adding the high-frequency component selected by the selector to the synthetic video signal outputted by the synthesizer.

8. The digital camera as claimed in claim 1, wherein
the generator generates the visible light video signal with an R signal and a G signal included, and the adjuster separately changes a signal level of the R signal and a signal level of the G signal based on the adjusted synthesis ratio.

9. The digital camera as claimed in claim 1, wherein
the adjuster changes a signal level of each color in the synthetic video signal based on the adjusted synthesis ratio.

10. The digital camera as claimed in claim 1, wherein
the display unit generates and displays a synthesis ratio indicating image having such a gray level that corresponds to the synthesis ratio.

11. A digital camera comprising:
a generator for generating a visible light video signal by receiving visible light and generating an invisible light video signal by receiving invisible light;
a synthesizer for synthesizing the visible light video signal and the invisible light video signal;
a visible light high-pass filter for extracting a high-frequency component of the visible light video signal;
an invisible light high-pass filter for extracting a high-frequency component of the invisible light video signal;
a selector for comparing a signal level of the high-frequency component of the visible light video signal extracted by the visible light high-pass filter and a signal level of the high-frequency component of the invisible light video signal extracted by the invisible light high-pass filter and selecting one of the high-frequency component of the visible light video signal and the high-frequency component of the invisible light video signal based on the comparison result; and
an adder for adding the high-frequency component selected by the selector to a synthetic video signal outputted by the synthesizer.

12. A digital camera comprising:
a generator for generating a visible light video signal by receiving visible light and generating an invisible light video signal by receiving invisible light;
a synthesizer for synthesizing the visible light video signal and the invisible light video signal in such a manner that a synthesis ratio can be changed;
an adjuster for receiving parameters relating to image synthesis inputted by an operator from outside and adjusting the synthesis ratio based on the received parameters; and
a display unit for generating a synthetic image from a synthetic video signal obtained by the synthesizer and displaying the synthetic image, wherein
the generator generates the visible light video signal with an R signal and a G signal included, and the adjuster separately changes a signal level of the R signal and a single level of the G signal based on the adjusted synthesis ratio.

13. A digital camera comprising:
a generator for generating a visible light video signal by receiving visible light and generating an invisible light video signal by receiving invisible light;
a synthesizer for synthesizing the visible light video signal and the invisible light video signal in such a manner that a synthesis ratio can be changed;
an adjuster for receiving parameters relating to image synthesis inputted by an operator from outside and adjusting the synthesis ratio based on the received parameters; and
a display unit for generating a synthetic image from a synthetic video signal obtained by the synthesizer and displaying the synthetic image, wherein
the adjuster separately changes a signal level of each color in the synthetic video signal based on the adjusted synthesis ratio.

14. A digital camera comprising:
a generator for generating a visible light video signal by receiving visible light and generating an invisible light video signal by receiving invisible light;
a synthesizer for synthesizing the visible light video signal and the invisible light video signal in such a manner that a synthesis ratio can be changed;
an adjuster for receiving parameters relating to image synthesis inputted by an operator from outside and adjusting the synthesis ratio based on the received parameters; and
a display unit for generating a synthetic image from a synthetic video signal obtained by the synthesizer and displaying the synthetic image, wherein
the display unit generates and displays a synthesis ratio indicating image having such a gray level that corresponds to the synthesis ratio.
